(19) United States
(12) Patent Application Publication
(10) Pub. No.: US 2017/0374245 A1
(43) Pub. Date: Dec. 28, 2017

(54) DEVICE AND METHOD FOR CAUSING A TARGETED REACTION BY A SUBJECT WHEN CAPTURING AN IMAGE

(71) Applicant: Christopher J. Rolczynski, West Hollywood, CA (US)

(72) Inventor: Christopher J. Rolczynski, West Hollywood, CA (US)

(21) Appl. No.: 15/630,782

(22) Filed: Jun. 22, 2017

Related U.S. Application Data
(60) Provisional application No. 62/354,006, filed on Jun. 23, 2016.

(51) Int. Cl. H04N 5/222; H04M 1/725; G06T 11/60; H04N 5/265; G06F 3/0484

(52) U.S. Cl. CPC H04N 5/2222; H04N 5/265; G06F 3/0484; G06T 11/60; H04M 1/72555

(57) ABSTRACT

A method for capturing an image obtained with a device includes using the device so that the device accesses a camera of the device, provides a user interface on the device, displays a near real-time image obtained by the camera within the user interface, provides a plurality of selectable device actions adapted to cause a targeted reaction by a subject to the device, triggers a device action based on a selection by a user from the plurality of selectable device actions and captures an image obtained with the camera subsequent to triggering the device action.

### CLAIM OF PRIORITY

This application claims the benefit of priority to U.S. Provisional Application titled “DEVICE AND METHOD FOR CAUSING A TARGETED REACTION BY A SUBJECT WHEN CAPTURING AN IMAGE”, Application No. 62/354,006, filed Jun. 23, 2016, which application is herein incorporated by reference.

### FIELD OF INVENTION

Embodiments of the invention are generally related to creating images, including photography and videography. In particular, embodiments of the invention are related to devices and methods for capturing the attention of a subject of a photograph or video, including digital photographs and videos.

### BACKGROUND

Today, nearly everyone carries a mobile phone. Many of those mobile phones are smart phones equipped with cameras. In addition, many people carry tablet computers and other devices equipped with cameras. These devices are often used to capture photographs and videos of the device user, alone or with others in what are called “selfies”. However, it can be difficult to capture the attention of the subject of the photograph and video when that subject does not understand or is not aware that a photograph and video is being taken. For example, when that subject is an animal or a baby.

### SUMMARY

In accordance with an embodiment, described herein is a device, a method for capturing an image obtained with the device and a non-transitory computer readable storage medium of the device having instructions thereon which when executed by the device causes the device to capture the image. The method includes using the device to cause the device to access a camera of the device, provide a user interface on the device, display a near real-time image obtained by the camera within the user interface, provide a plurality of selectable device actions adapted to cause a targeted reaction by a subject to the device, trigger a device action based on a selection by a user from the plurality of selectable device actions and capture an image obtained with the camera subsequent to triggering the device action.

In accordance with an embodiment, the plurality of device actions is presented to the user in a scrollable menu or list of icons or text displayed in the user interface. The device action can be one or both of an audial and a visual cue. Where the device action is a visual cue, the visual cue is displayed on the user interface.

In accordance with an embodiment, the plurality of device actions selectable by the user includes one or both of one or more audial cues and one or more visual cues that draw an attention of a dog. The one or more audial cues can be associated with one or more of a dog toy and an animal call.

In accordance with an embodiment, the plurality of device actions selectable by the user includes one or both of one or more sounds and one or more visuals that draw an attention of a child.

In accordance with an embodiment, the plurality of device actions selectable by the user includes one or more sounds captured by the user via the device. Additionally or alternatively, the plurality of device actions selectable by the user includes one or more visuals captured by the user via the device.

### BRIEF DESCRIPTION OF THE FIGURES

These and other aspects, features and advantages will be apparent and elucidated from the following description of various embodiments, reference being made to the accompanying drawings, in which:

FIG. 1 illustrates a device and an application for causing a targeted reaction by a subject to the device, in accordance with an embodiment.

FIG. 2 illustrates a device and an application for causing a targeted reaction by a subject to the device, in accordance with a further embodiment.

FIGS. 3A and 3B illustrate a device and an application for causing a targeted reaction by a subject to the device, in accordance with a further embodiment.

FIG. 4 illustrates a device and an application for causing a targeted reaction by a subject to the device, in accordance with a further embodiment.

FIG. 5 illustrates a device and an application for causing a targeted reaction by a subject to the device, in accordance with a further embodiment

FIGS. 6A and 6B illustrate a device and an application for causing a targeted reaction by a subject to the device, in accordance with a further embodiment.

FIG. 7 illustrates a device and an application for causing a targeted reaction by a subject to the device, in accordance with a further embodiment.

FIGS. 8A and 8B illustrate a device and an application for causing a targeted reaction by a subject to the device, in accordance with a further embodiment.

FIG. 9A and 9B illustrate a device and a community screen for use with an application for causing a targeted reaction by a subject to the device, in accordance with a further embodiment.

### DETAILED DESCRIPTION

Embodiments will now be described more fully hereinafter. Embodiments can comprise many different forms and should not be construed as limited to those set forth herein; rather, these embodiments are provided by way of example so that this disclosure will be thorough and complete, and will fully convey the scope of the invention to those persons skilled in the art. Like reference numbers refer to like elements or method steps throughout the description.

It would be apparent to one of skill in the art that the present invention, as described below, may be implemented in many different embodiments of hardware, software, firmware, and/or the entities illustrated in the figures. Further, the examples given for audial and visual cues or other actions (e.g., vibration of device, pulsing of camera flash, etc.) generated and/or used in the figures and description are merely exemplary. Any actual software, firmware and/or hardware described herein, as well as any audial and visual cues or other actions generated thereby, is not limiting of the present invention. Thus, the operation and behavior of the present invention will be described with the understanding that modifications and variations of the embodiments are possible, given the level of detail presented herein.

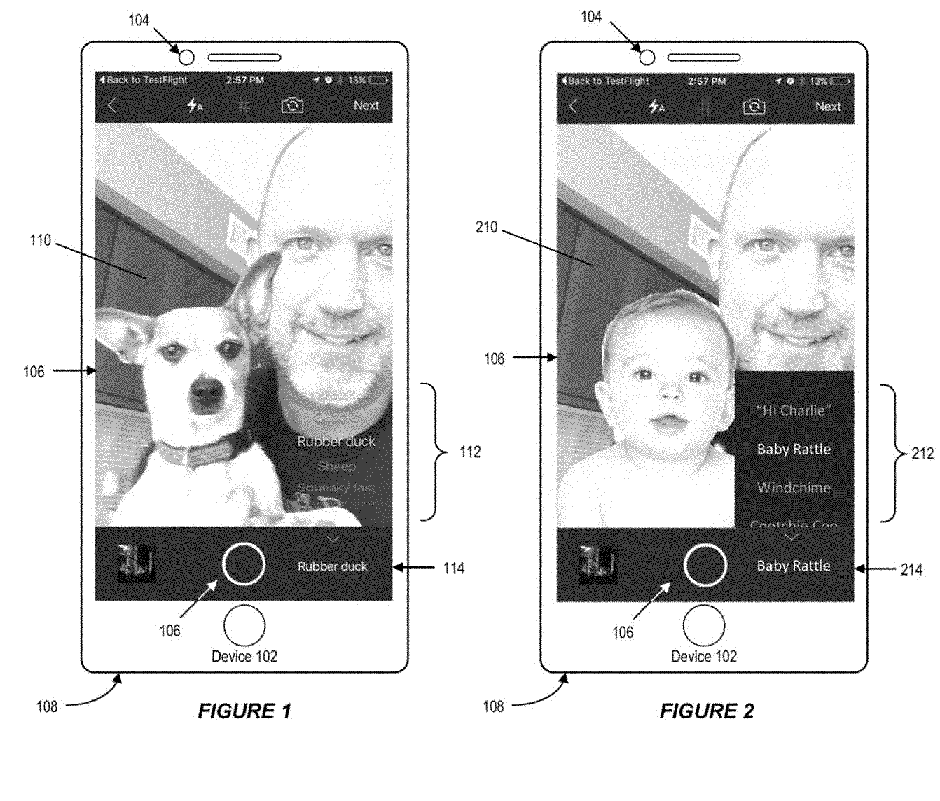

FIG. 1 illustrates a device 102 and a software application running on the device for causing a targeted reaction by a subject to the device, in accordance with an embodiment. As shown, the device is a smartphone equipped with a camera 104, speakers 108 and a display 106 which is shown displaying an interface 110 of the software application, in accordance with an embodiment. The software application can comprise instructions stored on a non-transitory computer readable storage medium of the device, which when read and executed by the device cause the software application to run on the device. In other embodiments, the software application can be used on a device other than a smartphone, such as a media player, a tablet, a laptop computer, a desktop computer, etc.

As shown, the interface for the software application provides a near real-time image obtained by the camera within the user interface. Some subjects of photographs and videos, such as pets (e.g., dogs, cats, miniature therapy horses) and small children can be easily distracted or unaware that they are being posed for a photograph or video. Traditionally, a photographer or videographer could wave an object or use a clicker, for example, to draw the subject's attention to the photographer or videographer, who would then take the photograph or video. However, when the photographer or videographer and the subject are in the camera's frame, such as when taking a self-portrait (or “selfie”), it can be difficult for the photographer or videographer to draw the subject's attention to the camera.

As used hereinafter, the term “image” will refer to a likeness or representation of a person, animal, or thing and will include but not necessarily be limited to a still photograph, a set of photographs, and a series of moving images, such as in a video, whether captured digitally or on a physical medium. Likewise, the term “imager” will refer to an image creator including but not necessarily limited to a photographer capturing a photograph or series of photographs and a videographer capturing video.

Devices, methods and software applications in accordance with embodiments can be applied to draw the subject's attention so that the subject appears to be looking generally at the camera. The interface of the software application can provide access to device actions, such as audial and/or visual cues designed to cause the targeted reaction of looking generally toward the camera. As shown in FIG. 1, a device action comprising an audial cue can be used cause the targeted reaction. As shown, a menu 112 is displayed within the interface that allows the imager to select the cue. The menu can be a list of text, icons or a mixture of text and icons and can run vertically from top-to-bottom or from side-to-side. Alternatively, a single option represented by a text or icon is shown at a time and changes as the user moves through the options.

As shown, the imager can scroll through the menu, for example by swiping up and down, or by some other means (e.g., by using other virtual buttons displayed on the interface or by depressing a physical button, such as the volume up and down buttons). Alternatively or additionally, the software application can use voice commands to display and move through the menu and to select the desired cue. The selected cue 114 is displayed next to a shutter button 111. It is noted that most modern camera phones use a “virtual” shutter, and as used herein the term shutter is intended to represent any trigger to cause an image or images to be capture for storage in a photo library or otherwise archived by the triggerer.

As shown, the selected audial cue is “Rubber duck.” When the audial cue is triggered, the device will produce a rubber duck squeaking sound through the speakers which can occur once, or alternatively can continue until the shutter button on the interface is pressed. The audial cue can be triggered once it is selected from the menu, once the selected cue is pressed on the interface, or alternatively can be triggered some other way, such as by pressing the shutter button a first time, with the photo being taken by then pressing the shutter button a second time. Alternatively, the triggering of the shutter can be a timed event following a cue, so that a single press of the shutter button can trigger both events in sequence. Alternatively, a “long shot” option can be used, whereby the user can press and hold the shutter to play the selected audio continuously until the user releases the shutter, thereby both stopping the audio playback, as well as taking the photo.

The software application can provide menu options for different subject types, and additionally or alternatively can provide different sets of menus for different subject types. Referring to FIG. 2, a set of audial cues is provided in a menu 212 targeted toward a baby. The menu is displayed in the interface 210 and the imager has selected “Baby Rattle” 214 from options that include “Wind chime” and the spoken words “Hi Charlie”.

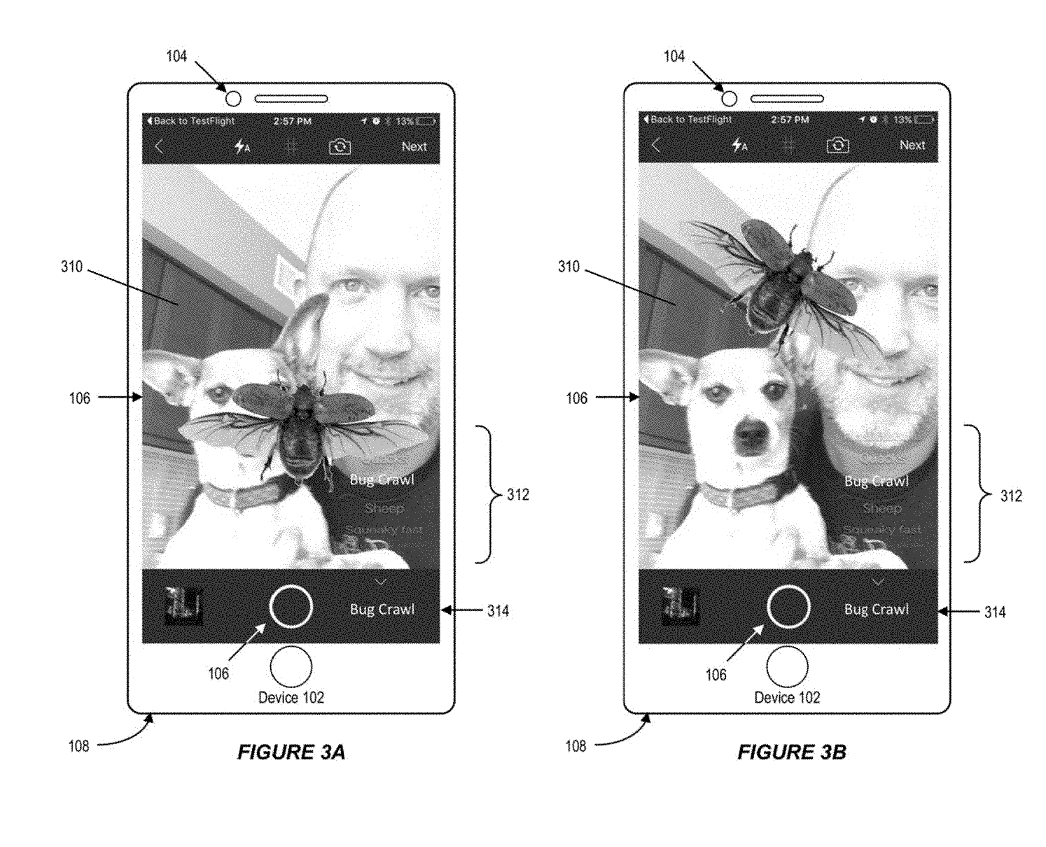

In addition, or instead of, an audial cue, the menu can provide options for device actions in the form of visual cues. Referring to FIGS. 3A and 3B, a visual cue can include a moving graphic on the interface 310. For example, as shown an option 314 selected from a menu 312 of audial and visual cues labeled “Bug Crawl” results in a beetle “crawling” over the display toward the camera, drawing a dog's attention toward the camera.

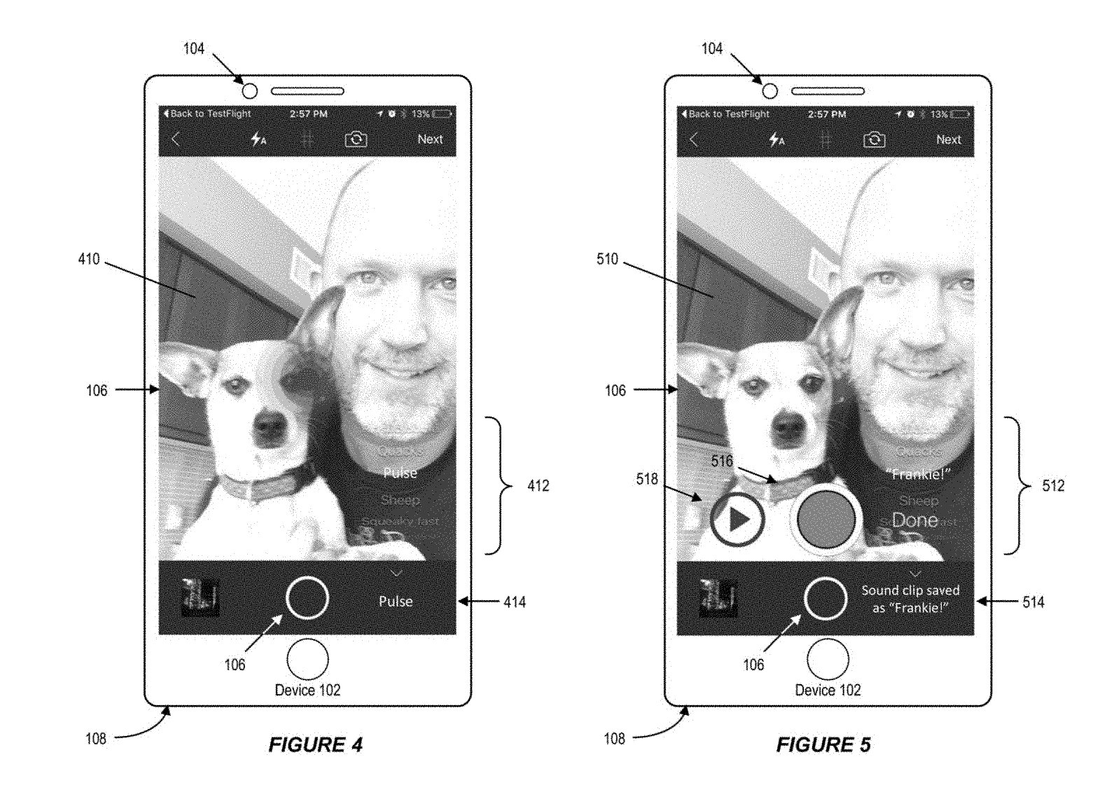

Referring to FIG. 4, a visual cue can include a pulsing or otherwise changing light on the interface 410. For example, as shown an option 414 selected from a menu 412 of audial and visual cues of “Pulse” results in a pulsed red light appearing in the center of the display 410. Dogs and cats are often drawn laser pointers. A “laser pointer”-like light can be emitted from the display and jump around in the fashion of a laser pointer, or move from the bottom of the display toward the camera, for example.

Device actions can combine audial and visual cues. For example, if the subject is a toddler, a visual cue appealing to a toddler can be used combining both audial and visual elements, such as a rattle displayed and wiggled while a rattle sound emits from the speakers of the device.

To avoid obscuring the display and preventing the imager from seeing the subject (and the imager), larger graphics can disappear and reappear, or visual cues can be strategically placed on the display, or alternatively, the near real time image produced from the camera can be sized smaller than the display with space dedicated to the visual cue. A resized camera image may be more easily implemented where the display size is quite large, for example with tablet computers or large sized smartphones.

In accordance with a further embodiment, the software application can provide the ability for the imager to record an audial cue. Referring to FIG. 5, when recording the audial cue, the interface can provide a record button 516 and a playback button 518. The recorded audial cue can be saved, for example by pressing the shutter button. As shown, calling the dog's name “Frankie!” is saved to the menu 512 as a sound clip titled “Frankie!” 514.

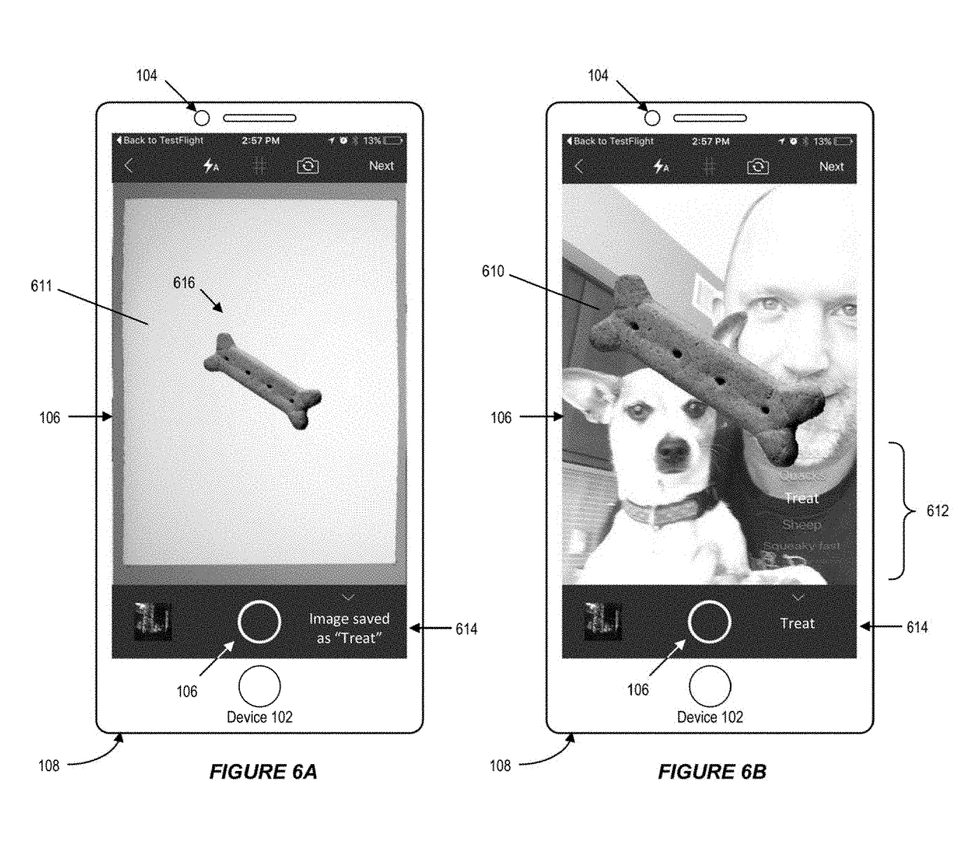

In accordance with a further embodiment, the software application can provide the ability for the imager to create a visual cue. Referring to FIGS. 6A and 6B, when creating the visual cue, a favorite toy or treat can be imageed using the camera, for example against a background that allows the software application to clearly identify the edges of the object. In this case, the software application then creates a visual cue comprising a treat 616 that appears on the display 610 from an image of the treat taken against a white sheet of paper displayed on the interface 611 and captured by pressing the shutter button. The created visual cue can be saved, for example by pressing the shutter button. As shown, the photo of the treat is saved to the menu 612 as an image titled “Treat” 614.

In addition to the audial and visual cues described above, which are intended to draw the attention of a subject as the targeted reaction, in still other embodiments, the reaction targeted by the software application can be a smile, rather than attention. For example, where a person's has trouble smiling or is generally disinterested, a set of menus can provide jokes or comments that are designed and intended to invoke smiles or laughter. The software application can be combined with techniques for detecting “smiles” in images and automatically trigger the shutter when the targeted reaction is detected.

In accordance with an embodiment, different sets of menus of audial and visual cues can be offered within the software application via micro-transactions. For example, a set of menus designed for drawing the attention of dogs, cats, toddlers, etc., or for producing a smile can be made available. Audial and visual cues can also target other reactions. For example, audial and visual cues can target a surprised or shocked reaction (e.g., a “haunted house” reaction). The targeted reaction described herein are merely examples.

While the imager may interact with the touchscreen of the device to select from the menu or otherwise use the interface, if the device is a laptop or desktop, for example, the imager may alternatively use the interface via a keyboard or other peripheral.

In a typical use scenario, the imager wants to focus on the near real time image displayed on the screen, or otherwise avoid obscuring the display. In addition, it can be cumbersome and unwieldy to press the shutter button while holding the device with one hand. This can require reaching with a thumb, which can be change the position of the camera as well as the device.

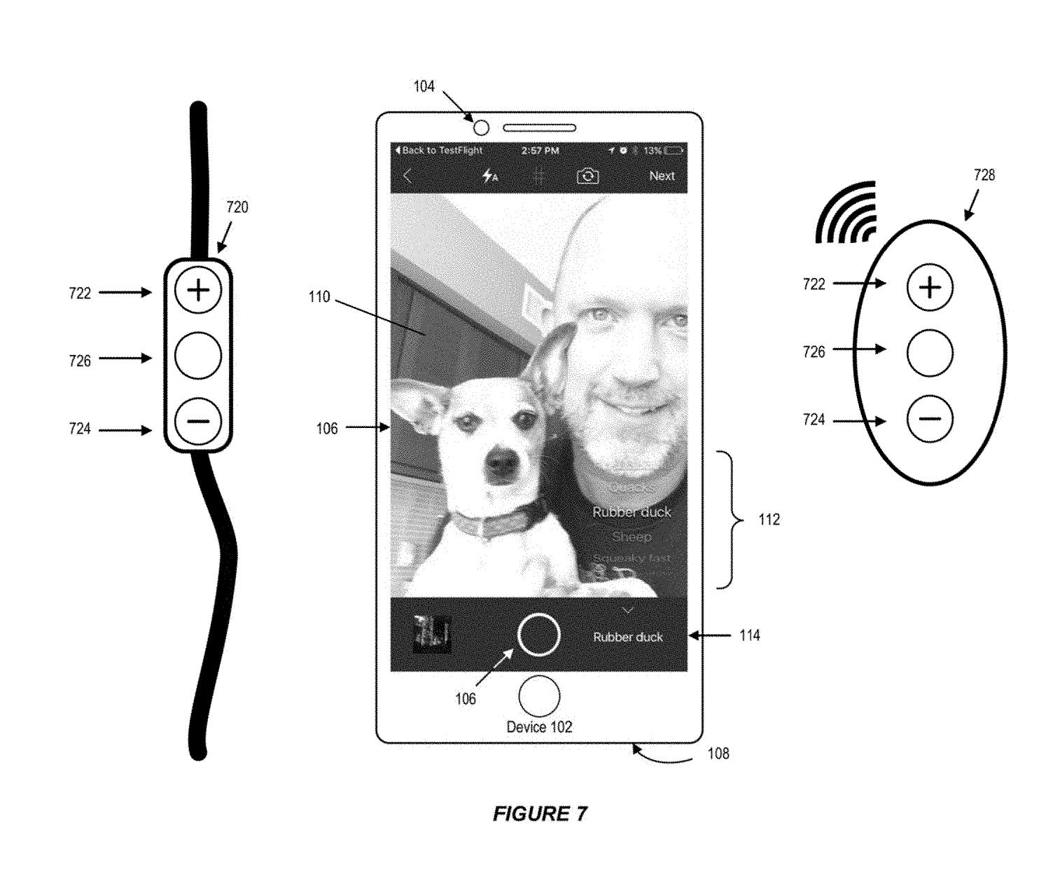

Referring to FIG. 7, in-line remotes 720 are common and can be found, for example, along the wires connecting headphones or earbuds to a device. Most in-line headphone and earbud remotes support volume control (+/−), but also include at least a third button that can be used to start and stop playback of media content on the device, for example. In accordance with an embodiment, the software application can assign different functionality to these buttons. For example, the volume increase button 722 can be clicked to move up in the menu of device actions, while the volume decrease button 724 can be clicked to move down in the menu of actions. The third button 726 can be used to activate the device action(s) and/or activate the shutter to capture the image obtained by the camera. By using the in-line remote, the imager avoids obscuring the display and can simplify the task of capturing the image for imager, who may be holding the subject for example in the case of a pet or a toddler.

Alternatively, a wireless remote 728 can be used for interacting with the interface, selecting and initiating a device action, and activating the shutter command. The wireless remote can communicate with the device via Bluetooth, for example, or some other wireless technology, including via a third device such as a wireless router. The wireless remote may have a similar button layout as discussed with respect to in-line remotes, or the wireless remote may have a different button layout. Further, in an embodiment, the application can allow for custom button layouts by allowing a user to assign functionality to buttons of a wireless remote.

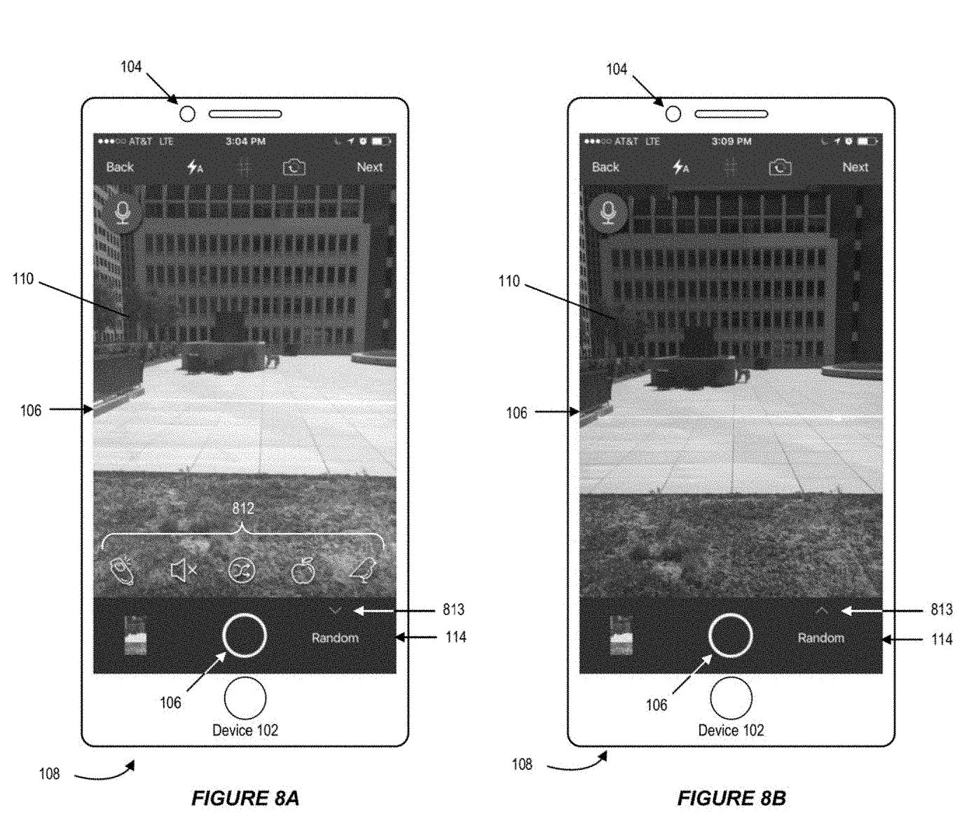

FIGS. 8A and 8B illustrates an alternative layout of device actions. A menu 812 is displayed within the interface that allows the imager to select an audial cue. As shown, the menu is a set of icons displayed from side-to-side. A user interacts with the interface to scroll through the available actions from left-to-right or right-to-left and can select the cue by touching the icon. Also provided is an icon for “Random” that allows the application to randomly choose and activate a device action upon command. As the user scrolls through the icons the menu can loop back to the beginning once the last available icon is displayed. Above the display of the selected cue “Random” is an icon 813 that can allow the user to selectively disappear and reappear the menu of icons.

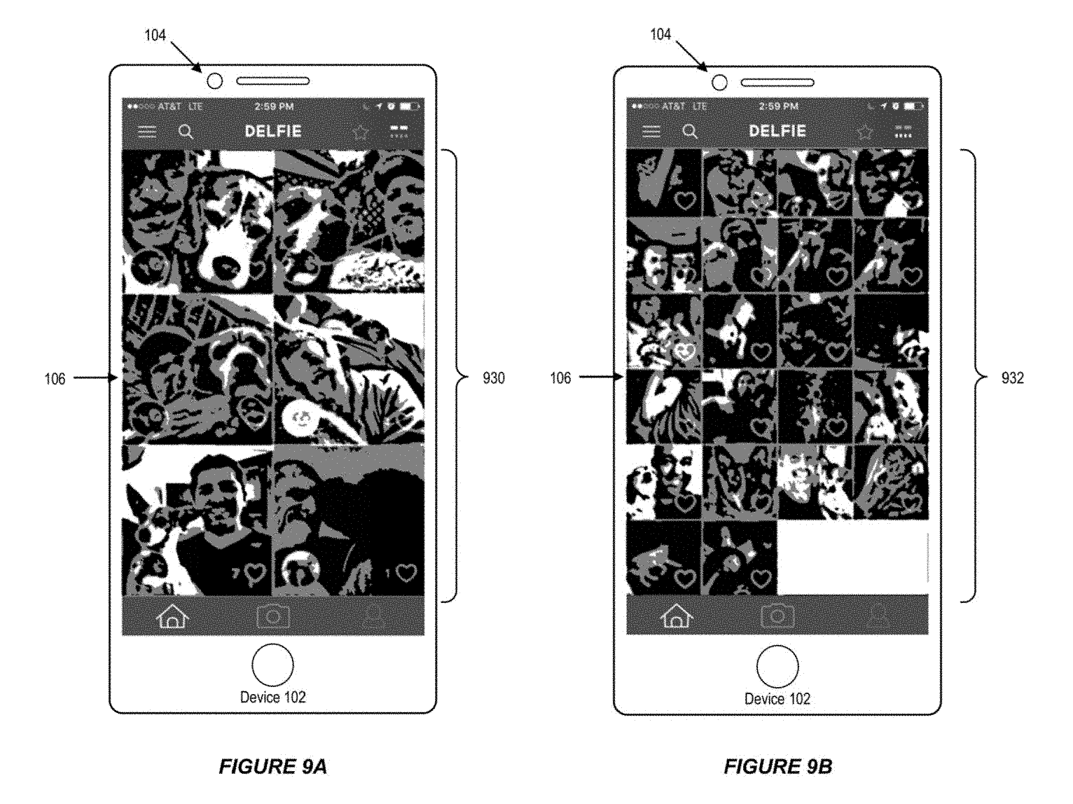

Referring to FIGS. 9A and 9B, in accordance with an embodiment, a user can connect with a community of other users of the software application. The community of users can be connected with or through another service, such as an existing social network(s), or the community of users can be built and managed exclusively through and within the software application itself. Users can post photos taken via the application to the community. The software application can enable the community to interact with the posted photos. For example, a user may be able to interact with posted photos by one or more of “liking” posted photos, commenting on posted photos, favoriting posted photos, etc.

A user can access the community through the interface. As shown, photos from the community are displayed as a series of tiles that can be decreased in size and increased in number by the user. Alternatively, the photos can be displayed in some other fashion, such as in list or “blog” format. In some embodiments, the community can comprise all users of the software application. Optionally, the user can then choose to follow certain other users or block certain other users. Alternatively, the community can be limited to users identified by the user as “friends” via the software application, or via a social network, for example.

In an embodiment, cues recorded or otherwise created by any user within the community can be offered to other users within the community, for example via download. The offer can be free or alternatively the user can choose whether to offer cues (or other content) for compensation. Cues (and other content) can be made individually available, or can be made available in a package, for example according to a theme. Likewise, all available content can optionally be grouped into themes. In this way photos, cues and optionally other content can be shared amongst the community.

Information gathered by the software application can be stored locally on the user's device, in cloud storage remote from the user's device, or in some combination of local and cloud storage. For example, only photos posted by a user to the community of users are stored in cloud storage, while photos that have not been shared by the user are stored locally on the device. Alternatively, all photos can stored in cloud storage, or the software application can give the user the option to store photos locally or remotely in cloud storage.

In some embodiments, the present invention includes a computer program product which is a non-transitory storage medium or computer readable medium (media) having instructions stored thereon/in which can be used to program a computer to perform any of the processes of the present invention. Examples of the storage medium can include, but is not limited to, any type of disk including floppy disks, optical disks, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

1. A non-transitory computer readable storage medium, including instructions stored thereon which when read and executed by a device having one or more processers cause the device to perform the steps comprising:
accessing a camera of the device;
providing a user interface on the device;
displaying a near real-time image obtained by the camera within the user interface;
providing a plurality of selectable device actions adapted to cause a targeted reaction by a subject to the device;
triggering a device action based on a selection by a user from the plurality of selectable device actions; and
capturing an image obtained with the camera subsequent to triggering the device action.

2. The non-transitory computer readable storage medium of claim 1, wherein the plurality of device actions is presented to the user in a scrollable menu displayed in the user interface.

3. The non-transitory computer readable storage medium of claim 1, wherein the device action is one or both of an audial cue and a visual cue.

4. The non-transitory computer readable storage medium of claim 3, wherein the visual cue is displayed on the user interface.

5. The non-transitory computer readable storage medium of claim 3, wherein the plurality of device actions selectable by the user includes one or both of one or more audial cues and one or more visual cues that draw an attention of a dog.

6. The non-transitory computer readable storage medium of claim 5, wherein the one or more audial cues are associated with one or more of a dog toy and an animal call.

7. The non-transitory computer readable storage medium of claim 3, wherein the plurality of device actions selectable by the user includes one or both of one or more sounds and one or more visuals that draw an attention of a child.

8. The non-transitory computer readable storage medium of claim 3, wherein the plurality of device actions selectable by the user includes one or more sounds captured by the user via the device.

9. The non-transitory computer readable storage medium of claim 3, wherein the plurality of device actions selectable by the user includes one or more visuals captured by the user via the device.

10. A method for capturing an image obtained with a device having a camera and a display, the method comprising:
using the device, wherein the device includes a non-transitory computer readable storage medium having instructions stored thereon which when read and executed by the device causes the device to:
access a camera of the device;
provide a user interface on the device;
display a near real-time image obtained by the camera within the user interface;
provide a plurality of selectable device actions adapted to cause a targeted reaction by a subject to the device;
trigger a device action based on a selection by a user from the plurality of selectable device actions; and
capture the image obtained with the camera subsequent to triggering the device action.

11. The method of claim 10, wherein the plurality of device actions is presented to the user in a scrollable menu displayed in the user interface.

12. The method of claim 10, wherein the device action is one or both of an audial and a visual cue.

13. The method of claim 12, wherein the visual cue is displayed on the user interface.

14. The method of claim 12, wherein the plurality of device actions selectable by the user includes one or both of one or more audial cues and one or more visual cues that draw an attention of a dog.

15. The method of claim 14, wherein the one or more audial cues are associated with one or more of a dog toy and an animal call.

16. The method of claim 12, wherein the plurality of device actions selectable by the user includes one or both of one or more sounds and one or more visuals that draw an attention of a child.

17. The method of claim 12, wherein the plurality of device actions selectable by the user includes one or more sounds or one or more visuals captured by the user via the device.

18. A device, comprising:
one or more processors;
a camera;
a display; and
a non-transitory computer readable storage medium having instructions stored thereon which when read and executed by the device causes the device to:
access the camera of the device,
provide a user interface on the display of the device,
display a near real-time image obtained by the camera within the user interface,
provide a plurality of selectable device actions adapted to cause a targeted reaction by a subject to the device,
trigger a device action based on a selection by a user from the plurality of selectable device actions, and
capture the image obtained with the camera subsequent to triggering the device action.
